(19) United States
(12) Patent Application Publication
(10) Pub. No.: US 2002/0010621 A1
(43) Pub. Date: Jan. 24, 2002

(54) Incentives for content consumption

(76) Inventors: Christopher Nathan Bell, Acworth, GA (US); Michael Jay Becker, Atlanta, GA (US); William Christopher Carson, Acworth, GA (US); Mark Leslie Henry, Marietta, GA (US); Robert Steven Glassley, Woodstock, GA (US); Bernadette O?apos;Grady DiMauro, Acworth, GA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/805,678

(22) Filed: Mar. 13, 2001

Related U.S. Application Data
(60) Provisional application No. 60/219,277, filed on Jul. 19, 2000.

(51) Int. Cl. G06F 17/60

(52) U.S. Cl. 705/10; 705/14; 709/231

(57) ABSTRACT

Systems for incentive enabling and demographic generation in order to allow content owners, distribution entities, advertisers and others to learn more about consumers and to incentivize comsumption of certain media products, infrastructure devices, or consumer products, among others. Preferably, systems according to the present invention include an integrating functionality which receives, stores and processes certain user demographic information with user content activity information, such as, for instance, streaming a particular song by a particular artist for a particular number of milliseconds, in order to award points or other incentives and to map various characteristics of content being consumed against user demographics. Functionality at the client level monitors content being streamed and reports information about that content, together with user demographic information, to the integrating functionality, or when the user is not logged in stores it locally for later reporting. Other functionality at the client level allows the user to navigate the integrating functionality, logon, check incentive account status, update contact information, participate in redemption of rewards, and perform other activities.

### RELATED APPLICATIONS

This application is a continuation-in-part of U.S. application No.—, filed on Jan. 19, 2001 entitled Systems and Processes For Measuring, Evaluating and Reporting Audience Response to Audio, Video, and Other Content, which is incorporated herein by reference. This application claims the benefit of U.S. Provisional Application No. 60/219,277, which is incorporated herein by reference.

### FIELD OF THE INVENTION

The present invention relates to motivating user consumption of content, including streaming media on data networks, and to generating demographic information relating to consumption of content.

### BACKGROUND OF THE INVENTION

The Global Information Infrastructure, presently in the form of the Internet and the World Wide Web, creates new opportunities to distribute content, such as audio and visual content. Personal computers such as ones using Windows Operating System, typically include a media player such as Real Player, Microsoft Media Player, WinAmp, a combination of these, or other media players. These applications allow the user to address a remote site or presence on the web and initiate a session in which packets of digital content are sent by that server, received by the media player, processed, and rendered to the user in the form of, for instance, music or other sound, video, or a combined video and sound presentation. Content can also obviously be delivered by file transfer to which the present invention is also applicable.

The advent of streaming enabled terrestrial radio stations to stream their broadcasts for access by users worldwide. Thus, a listener in Atlanta can monitor the BBC broadcasts from the UK or streamed versions of terrestrial radio broadcasts from any station so enabled around the world. Additionally, so-called internet radio stations have appeared which “broadcast” solely on the internet. Thus, for instance, even though the Ministry of Sound in London currently has no terrestrial broadcasts, users can monitor its 24-hour live digital dance music broadcasts from anywhere. Similar streaming functionality may be implemented by any entity designed to do so, such as, for instance, record labels, conventional music distributors, or others who have appropriate authorization from content owners.

From the user's perspective, there are a plethora of sites to visit for streaming audio or video. Not only are there a wealth of options for various geographic locations, but also for any particular desired format. For example, the options for streaming techno music are overwhelming. The result can be considered a “cluttered” environment which creates for any content supplier statistical disadvantages against users visiting their site. In turn, such suppliers face more difficulty in maintaining the viability of their business model, whether it is founded on advertising, demographic sales, or other approaches.

The current streaming of audio tracks is considered by some record labels to be antihetical to or at least invasive of, their business model which is based on shipping and selling compact discs, DVDs or other tangible media. The record labels currently face difficulty in tracking how their Internet-distributed content is being distributed, who is listening to it, and what those listeners' demographics are, whether by age, sex, geographical location, or musical preferences, much less whether they are being compensated for such distribution. In the past, listener survey services such as Arbitron, which enrolls participants to complete and deliver listening logs for terrestrial broadcast stations, allowed tracking of listener response to the limited number of terrestrial radio stations in the United States and their playlists. Record labels also track purchases of CDs, DVDs and other media at points of sale using automated technology in an effort to gauge listener response according to the purchase proxy. Record labels use this information to promote sales by, among other things, advertising campaigns and pricing strategies.

Accordingly, the listener response and automated point-of-sale systems reinforce the record labels current business model. There is no general record label, much less content owner, business model as yet for the streaming distribution functionality, let alone strategies for promoting for certain content, certain channels or otherwise driving listener response.

### SUMMARY OF THE INVENTION

The present invention provides systems and processes for monitoring listener response to streaming network-distributed content, among other forms of content, generating demographic information and incentivizing content-related activity, whether in the form of increased number of listener visits on a site, lengthened stay on a site, consuming content from particular artists, labels, formats, albums, tracks, other characteristics of the content, or any combination or permutation of these.

Systems according to the present invention preferably include functionality which may be fully implemented at the user platform that monitors or observes what is being streamed and then reports that or parts of it to an integrating functionality, whether implemented at one location or more. The implementing functionality can award points or other incentives based on user identification, determinants or on any desired characteristic of the content that is being streamed. For instance, the number of points or quantity of incentives can be varied so that, for instance, zero points could be awarded for streaming a track by one artist and a standard number awarded for streaming a track by a second artist, and a greater quantity of points awarded for streaming a track by a third artist. Similar determinants include whether the content is audio or video, the brand of the media player, the URL of the streaming site, the artist, the track title, the track length, the total time streamed, or any other characteristic. As a result, the integrating functionality can receive, store, and track information such as about age, sex, and geographical location of a listener mapped to what that listener has actually streamed over time in order to map user demographics to content preferences. The user is incentivized in the form of more visits, particularly to premium incentive URLs or content, and record labels and others who seek to promote content have an opportunity to raise their content above the “clutter” as well as to understand what types of listeners where are resonating to what types of music at any particular time or times.

Systems according to the present invention can accordingly motivate consumption of media anywhere and in any market segment, as well as generate demographic information of use to record labels, terrestrial radio stations, internet radio stations, other streaming sites, other content owners and distributors, and advertisers. Thus, content owners can incentivize users to listen more often, for longer periods of time. They can obtain demographics in order to enhance, among other things, cross marketing campaigns such as mapping user demographic data and content activity information to particular consumer items in order to license a particular song to an automobile manufacturer for an advertising campaign to promote sales of a certain sports car. Record labels can now introduce the fan base of a particular artist to a new artist or artists, or otherwise cross-promote talent and/or content. Similar principles can be applied to movies or video content. Technology providers can now incentivize or motivate user demand for their particular media player or codec over others. Advertisers can promote and stimulate demand for their products not only through exposure on content streaming sites where user activity is demonstrated and proven, but also by obtaining demographic data to match content activity information to advertising response information. Similarly, advertisers can take advantage of information about users' product preferences learned through the auction process and/or through user activity on third party sites as reported through demographic information coupled with content activity information in order to focus and/or segment their marketing efforts.

### BRIEF DESCRIPTION OF THE DRAWINGS

FIG. 1 is a functional block diagram showing relationships of systems according to a preferred embodiment of the present invention with other entities on a network or networks.

FIG. 2 is a functional block diagram showing relationships of systems according to an alternative embodiment of the present invention with other entities on a network or networks.

FIG. 3 is a functional block diagram showing in more detail various functionalities which may reside on a user platform of FIG. 1.

FIG. 4 is a schematic diagram of tables which may be maintained according to user based functionalities according to a preferred embodiment of the present invention.

FIG. 5 is a functional block diagram showing a second embodiment of functionalities which may reside on a user platform of FIG. 1.

### DETAILED DESCRIPTION OF THE DRAWINGS

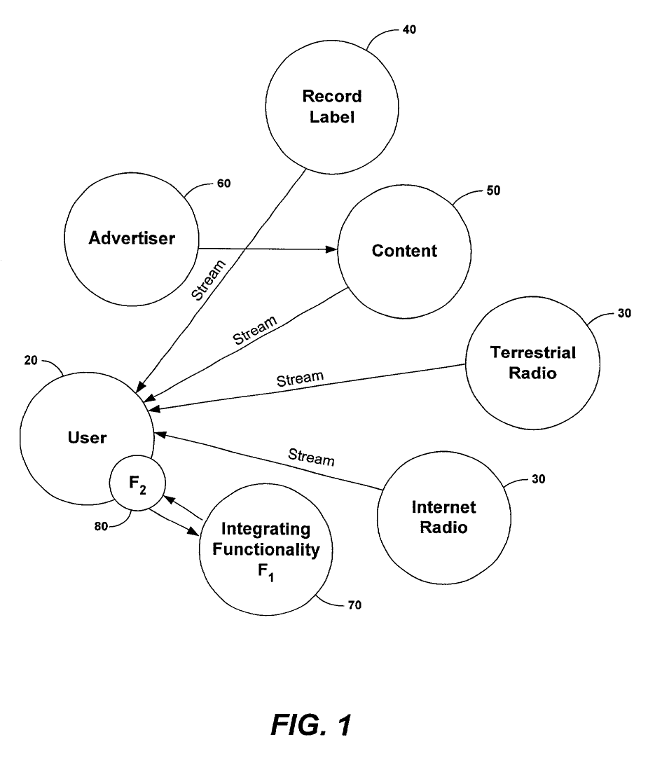

FIG. 1 shows a functional block diagram of systems according to the present invention and their interrelationship with other entities on a network or networks. Content in the form of audio, visual or other desired content, may be streamed or otherwise delivered (such as by file transfer) to a user 20.

User 20 may be any individual or entity equipped with a personal computer, a wireless device, a network, an internet appliance, a set top box, or any other platform or device adapted to receive and process content.

Content may be supplied from a live streaming site 30 such as terrestrial radio station or an internet radio station. Other presences which may stream or otherwise supply content include a record label 40, or any other content supplier 50, which could include any entity that desires to distribute content files by streaming, file transfer, or otherwise. Content streaming functionality which may be employed by entities 30-50 may be conventional, and the content may be supplied in any format desired. Current formats include those supplied by Real Player and Windows Media (Microsoft®).

Advertisers 60 may supply their content to any of sites 30-50 for promotion of their or others products or services. They may also supply products for auctions in which users redeem incentives according to the present invention. They may also test products in the auction process against demographic information learned through the auction process or otherwise learned in accordance with the present invention. Advertisers 60 obviously desire to place their content on sites which feature the best demographics, including user visits and length of stay. Systems and processes according to the present invention can stimulate advertiser participation on any of presences 30-50 as discussed other places in this document. They can also allow advertisers to focus and/or segment their efforts by using demographic information about user content-related activity on third party sites, coupled with demographic information about such users, whether or not the users respond to particular ads on particular pages.

In the preferred embodiment, as shown in FIG. 1, an integrating functionality (F₁) is a platform or network (or implemented as otherwise desired) which enables a number of operations functions. These include: (1) receiving, storing, and processing user demongraphic information and content activity information, (2) awarding incentives or points and tracking such awards, for various users who conduct various activities on any of presences 30-50; and (3) implementing redemption of such incentives. In a preferred embodiment, integrating functionality is implemented on a Windows 2000 server using Microsoft IIS Webserver Software and Microsoft SQI server as a relational database.

Cooperating with integrating functionality 70 is user or client functionality F₂, annotated with numeral 80 in FIG. 1. In the preferred embodiment, client functionality F₂ performs at least the following functions: (1) monitors at least portions of content received by a media player on user platform 20; (2) reports at least portions of identifying characteristics corresponding to the content to integrating functionality 70; (3) coordinates with the user platform 20 to store at the platform level such as in a registry, information necessary to operate client functionality F₂; and (4) allows the user to login to the integrating functionality and navigate the integrating functionality, and (5) supports an interface on user platform 20 which shows various status information including incentives, points, or other account information. In a preferred embodiment, client functionality 80 includes a media plugin such as a plugin that accommodates Real Player 7.0 or above, or the Microsoft Windows Media Player, and a plugin or application to display content provided by integrating functionality 70, all of which can operate on a Windows 2000 platform.

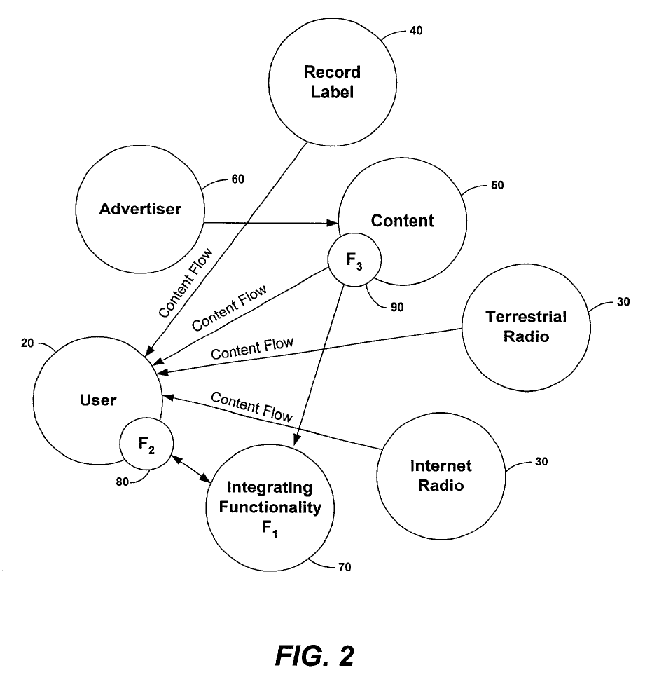

FIG. 2 is a functional block diagram which corresponds in some ways to FIG. 1, but shows at least a portion of functionality located at content supplier 50. Such content, for instance functionality F₃, denoted by numeral 90, can be necessary or useful in situations where other than streaming media is used or where parsing at the user level is otherwise not expedient or possible. This can include, for instance, file transfer operations or delivery of content that could be more easily designated or identified by content presence-side functionality rather than client-side functionality. Functionality 90 can send information directly to integrating functionality, or via client functionality 80.

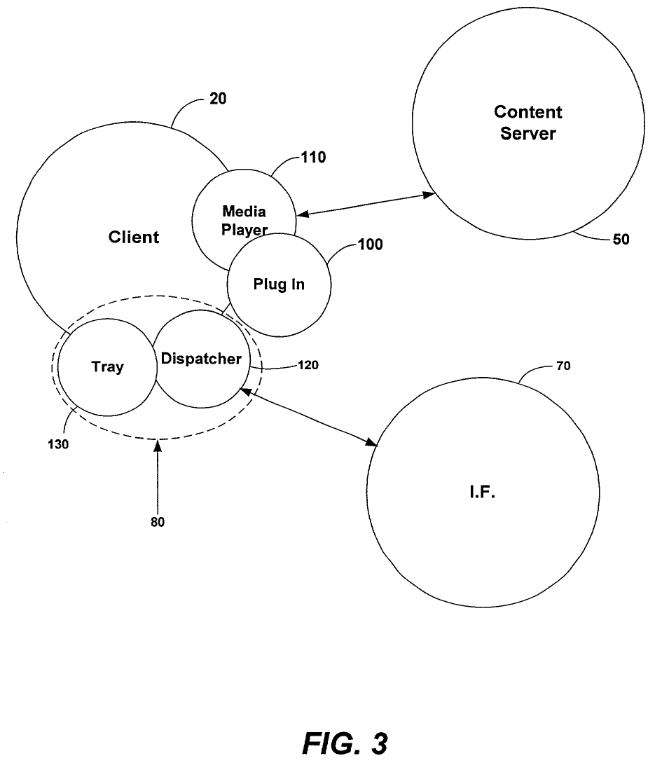

FIG. 3 shows client functionality 80 according to a preferred embodiment in greater detail. Generally, functionality 80 in this preferred embodiment includes a plugin 100 for media player 110, a dispatcher 120 and a tray application 130. Again, media player 110 may be any desired media player that accommodates any desired content stream and runs on a desired operating system. In the preferred embodiment, it is Real Player 7.0 or higher. It could just as easily be Microsoft Windows MediaPlayer or WinAmp.

Plugin 100 cooperates with Media Player 110 to monitor and report information about content being received by Media Player 110. Plugin 100 reports some or all of that information to dispatcher 120. Dispatcher 120, when it receives information from plugin 100, sends some or all of that information to integrating functionality 70 or, if unable to, such as when the user is not logged in, stores such information locally for later sending to integrating functionality 70. Tray application 130 works with user platform 20 and dispatcher 120 to accomplish a number of purposes including enabling the user to: (a) identify a variety of presences where the user can consume media and/or earn incentives or points; (b) navigate integrating functionality 70 such as to participate in an auction, sweepstakes, or redemption of fixed incentives; (c) perform account maintenance processes such as where the user checks incentives status and maintains customer contact information such as for shipping of rewards; (d) control the user interface and control panel where status of incentives and other information from integrating functionality 70 and perhaps other places can be displayed; and (e) gain access such as via appropriate passwords, authorization and other conventional or special techniques.

The plugin 100 according to the preferred embodiment can monitor user activity and report some or all of at least the following data to the dispatcher 120:

Player ID—int—a hard coded value, for instance, for Real Player

Type—string—an “A” or “V” to indicate audio or video

Codec—string—the name of the codec used to process the clip if available

URL—string—the title if available

Artist—string—the artist if available

Length—long—the length of the clip in milliseconds

Time—long—the time listened in milliseconds

Timestamp—long—the timestamp when the clip was completed (such as a numeric value representing the number of milliseconds since midnight GMT, Jan. 1, 1970)

BitRate—long—the bitrate the clip was recorded at in bits per second.

The dispatcher 120 listens for plugin-sent information, formats some or all of it and dispatches to integrating functionality 70. Notifications of activity can be sent at the end of a clip, when the user turns the stream off, or for live streaming media such as from radio stations, periodically such as, for instance, every 10 minutes.

The data for each activity will be contained in the query string. If a connection is not available or dispatcher is otherwise unable to send information to the integrating functionality 70, then the data will be stored locally. In the preferred embodiment, when the integrating functionality 70 processes an activity request it will return a page that contains <HTML>1 <HTML>for success or <HTML>0<HTML>to logout the current user. The dispatch data will include the following fields in the preferred embodiment:

MemberID—int—the logged in member's id

ActivityID—int—a hard coded value for all player monitors

PlayerID—int—a hard coded value for Real Player

Type—string—an “A” or “V” to indicate audio or video

Codec—string—the name of the codec used to process the clip if available

URL—string—the title if available

Artist—string—the artist if available

Length—long—the length of the clip in milliseconds

Time—long—the time listened in milliseconds

Timestamp—long—the timestamp when the clip was completed

BitRate—long—the bitrate the clip was recorded at in bits per second.

An example of content activity information message according to a preferred embodiment of the present invention appears as follows: http://www.backstagerewards.com/activity/?MemberID=23456&ActivityID=99&PlayerID=99&Type=A&Codec=X32GRReal32bitAudio&URL=http://www.lau nch.com/newclip.ra&Title=NewClip&Artist=NewArtist&Length=456787&Time=23445&Timestamp=4358745&BitRate=16.0

Tray application 130 navigates to a desired location on integrating functionality 70. Integrating functionality 70 determines whether the user is logged in and will either redirect to a login page or the proper logged in page. Once a user is logged in, she preferably stays logged in until logging out, even between user platform 20 reintializations.

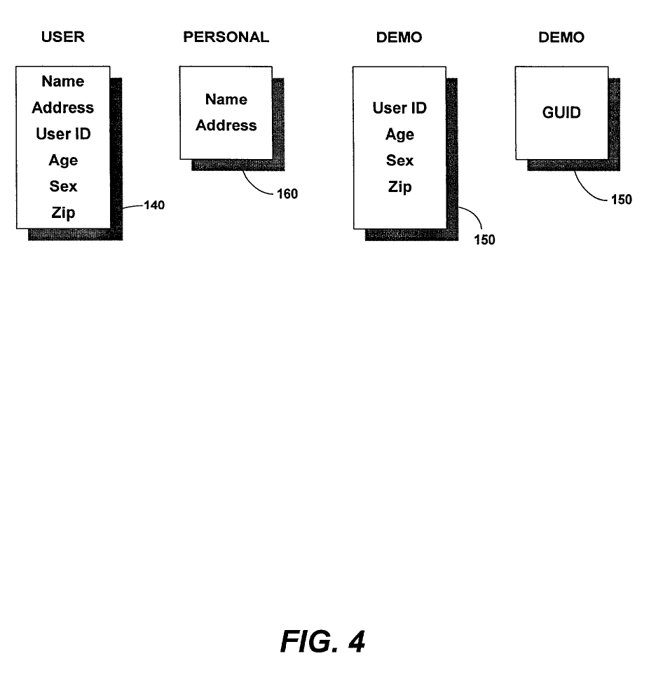

FIG. 4 shows tables which may be used in a preferred embodiment of the present invention to track user identification information. The user platform 20 may track using the user table 140. It includes, for instance, all of userID, age, sex and zip code information. It could contain information which is sensitive from a privacy or privacy regulation point of view and therefore is typically not used to communicate to integrating functionality 70 or any other presence or functionality outside of client system 20.

Demographic table 150 is the table that can be used to communicate with integrating functionality in order to identify user and map user activity to media consumption activity for point enabling, and other purposes. Demographic table 150 preferably contains information that is not sensitive from a privacy point of view. It may be built off or include parts of user table 140.

Personal table 160 contains identification information sufficient for shipping of prizes or awards when points or incentives have been redeemed. It may be built off of a portion of user table 140 and is preferably not used to communicate with any functionality that tracks demongraphic activity or user activity. Thus multi-table approach necessary mapping of user activity to occur with the aim of minimizing or eliminating privacy concerns while getting labels, content providers and owners, and others the demographic information they need about listener response to their music.

Demographic information could be supplanted merely by providing the global unique identification string or “GUID” for the appropriate media player or other client side application.

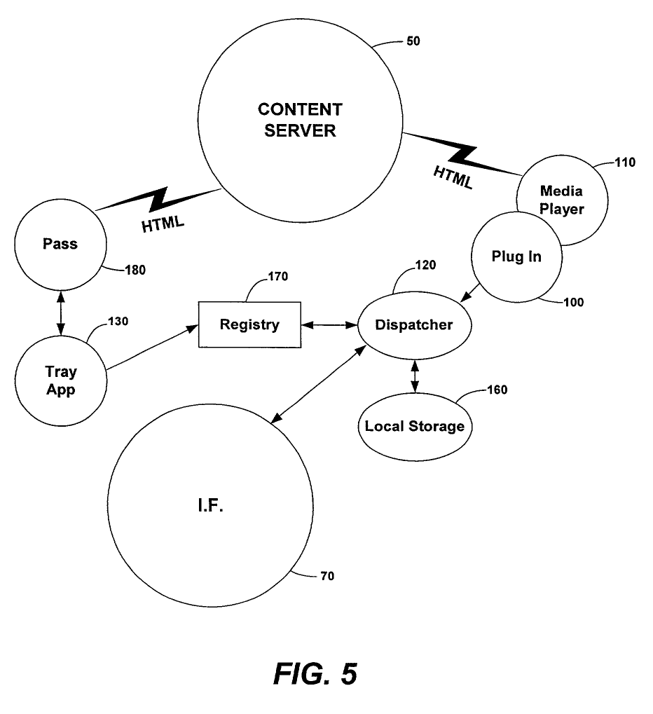

FIG. 5 shows another version of client-based functionality 80. There, content flows from a server 50 to a media player implemented on client system 20. Plugin 100 monitors the stream and dispatches relevant information to dispatcher 120 which sends all or part of such information to integrating functionality 70 or, if the user is not logged in, local storage 160. Dispatcher 120 works with platform 20 registry 170 to accomplish this. In any event, tray app 130 has preferably fed registry 170 at least member ID information for purposes of tracking and storing this information in local storage 160. Web application 180 which performs as the user visual interface and to make streaming selections on and otherwise navigate content server 50 is controlled by tray application 130.

Components of functionality 80 may be modularized in other ways or not modularized at all in order to communicate with and stream from content server 50, dispatch information to and communicate with integrating functionality 70, and allow the user to navigate and operate relevant parts of integrating functionality 70 in order to login, check account information, update status information, redeem incentives or points, or perform other activities. Some or any part of all of the functionalities of any of these modules, particularly plugin 100, can be implemented at the content server 50 level where, among other things, content being delivered can be more easily identified there and/or reported functionality 70 either directly or by way of client functionality 80.

Systems according to the present invention accordingly incentivize users to stream content from sites 30-50 while accruing incentives or points on integrating functionality 70. They also generate demographic and listener preference information which may be stored and tracked on integrating functionality 70. As a result, they provide several value propositions to content owners, technology providers, advertisers, distribution entities and others. These may be exploited in the form of raising content above the clutter for content owners, increasing number of visits, length of visit, or cumulative for distribution entities such as terrestrial or internet radio stations, and sale of demographic data or advertising opportunities. Incentive enabling and demographic generation functionalities according to the present invention can work with any form of media, including loyalty plans, such as for wireless operations, electronic commerce providers or others.

What is claimed is:

1. A system for tracking user demographics and content preferences, and for incentivizing user activity, comprising:
I. a user system adapted to monitor delivery of content from a separate content delivery entity, communicate user demographic information and user activity information to a separate integrating entity, and to enable a user to navigate at least part of said integrating entity, comprising:
a. a media player ancillary portion adapted to receive, parse and report to a dispatching portion content activity information about content being delivered to a media player by said separate content delivery entity;
b. a dispatching portion adapted to receive said content activity information and send at least part of said content activity information to said separate integrating entity; and
c. a command and control portion adapted to run on at least the operating system of a user device and to allow the user to navigate at least part of the integrating entity; and
II. a separate integrating entity adapted to receive user demographic information and content activity information from said user system, award incentives based on at least part of said content activity information, and enable users to redeem said incentives.

2. A system according to claim 1 in which the dispatching portion is adapted to store locally at least part of said content activity information when said dispatcher is unable to send said content activity information to said separate integrating entity.

3. A system according to claim 1 in which the dispatching portion is adapted to send user demographic information to said integrating entity.

4. A system according to claim 1 in which the media player ancillary portion is a plug-in application.

5. A system according to claim 1 in which the command and control portion is a tray application.

6. A system according to claim 1 in which the command and control portion supports a visual interface that enables the user at least to log onto and navigate at least part of the integrating entity.

7. A system according to claim 1 in which the user device is a personal computer.

8. A system according to claim 1 in which the user device is a set top box.

9. A system according to claim 1 in which the user device is a wireless device.

10. A system according to claim 1 in which the content delivery occurs via streaming audio and the media player ancillary portion parses at least a part of said streaming audio.

11. A system according to claim 1 in which all of the media player, dispatcher and command and control portions are implemented on said user device.

12. A system according to claim 1 in which at least part of at least one of said media player, dispatcher, and command and control portions are implemented on another device.

13. A system according to claim 12 in which at least part of any of said media player, dispatcher, and command and control portions are implemented at said content delivery entity.

14. A system according to claim 1 in which the user can redeem incentives in an auction.

15. A system according to claim 1 in which the user can redeem incentives in a sweepstakes.

16. A system according to claim 1 in which the incentives have a fixed value, and the user can redeem the fixed value incentives for rewards.

17. A system according to claim 1 in which the integrating functionality adjusts award of incentives according to at least one characteristic of the content being delivered.

18. A system according to claim 1 in which the integrating functionality adjusts award of incentives according to at least one characteristic of content delivery infrastructure.

19. A system according to claim 1 in which the integrating functionality adjusts award of incentives according to at least one characteristic of the user demographic information.

20. A system for motivating listener activity and generating demographic information relating to at least one of content and product, comprising:
I. a user system adapted to operate on a user device, which user device includes at least one content reception application, the user system including:
a. a monitoring computer program adapted to monitor delivery of content and generate content activity information based on content being delivered to said content reception application;
b. a communications computer program adapted to receive at least part of said content activity information and sent at least part of said content activity information, coupled with demographic information related to the user of the user device, to a separate central system; and
c. a coordination computer program adapted to enable the user to log onto said separate central system in order for at least part of said content activity information and user demographic information to be sent to said separate central system, and to enable the user to navigate at least part of said separate central system; and
II. a central system located separately from said user system, adapted to receive, store and process at least part of said content activity information and user demographic information from said user system, and to award incentives selectively and variably based on characteristics of at least said content activity information.

21. A system according to claim 20 in which the monitoring program is a media player plugin.

22. A system according to claim 20 in which the coordination program is a tray application.

23. A system according to claim 20 in which the coordination program supports a visual interface that enables the user at least to log onto and navigate parts of the central system.

24. A system according to claim 20 in which the user device is a personal computer.

25. A system according to claim 20 in which the user device is a set top box.

26. A system according to claim 20 in which the user device is a wireless device.

27. A system according to claim 20 in which the content delivery occurs via streaming audio and the monitoring program parses at least a part of the streaming audio.

28. A system according to claim 20 in which all of the monitoring program, communication program and coordination program are implemented on the user device.

29. A system according to claim 20 in which at least part of at least one of said monitoring, communication and coordination programs are implemented other than on the user device.

30. A system for motivating listener activity and generating content related demographic information, comprising:
I. a user system adapted to operate on a user device, which user device includes at least one content reception application, the user system including:
a. monitoring means for monitoring content being received by said content reception application and generating content activity information based on at least one characteristic of said content being received;
b. communication means for sending at least part of said content activity information to a separate central system; and
c. coordination means for allowing the user to log on to said central system and to navigate at least part of said central system in order to check status of incentives and to redeem at least part of said incentives; and
II. a central system located separately from said user system, comprising:
a. means for receiving, storing and processing at least part of said content activity information, and for awarding incentives at least partially selectively and variably based on characteristics of at least said content activity information.

31. A system according to claim 30 in which the monitoring means is a media player plugin.

32. A system according to claim 30 in which the coordination means is a tray application.

33. A system according to claim 30 in which the coordination means supports a visual interface that enables the user at least to log onto and navigate parts of the central system.

34. A system according to claim 30 in which the user device is a personal computer.

35. A system according to claim 30 in which the user device is a set top box.

36. A system according to claim 30 in which the user device is a wireless device.

37. A system according to claim 30 in which the content delivery occurs via streaming audio and the monitoring means parses at least a part of the streaming audio.

38. A system according to claim 30 in which all of the monitoring, communication and coordination means are implemented on the user device.

39. A system according to claim 30 in which at least part of at least one of said monitoring, communication and coordination means are implemented other than on the user device.

40. A process for motivating listener activity and generating content related demographic information, comprising:
I. in a user system adapted to operate on a user device, which user device includes at least one content reception application:
a. monitoring content being received by said content reception application and generating content activity information based on at least one characteristic of said content being received;
b. communication means for sending at least part of said content activity information to a separate central system; and
C. c. enabling the user to log on to said central system and to navigate at least part of said central system in order to check status of incentives and to redeem at least part of said incentives; and
II. in a central system located separately from said user system:
a. receiving, storing and processing at least part of said content activity information, and
b. awarding incentives at least partially selectively and variably based on characteristics of at least said content activity information.

41. A process according to claim 40 further comprising redeeming at least some of said incentives for a particular user in return for a reward.

42. A process according to claim 41 in which said redeeming occurs in an auction.

43. A process according to claim 41 in which said redeeming occurs in a sweepstakes.

44. A process according to claim 41 in which said redeeming occurs whereby said incentives have a fixed value.

45. A process according to claim 41 in which the process also generates product related information.
